(19) United States
(12) Patent Application Publication
(10) Pub. No.: US 2008/0247401 A1
(43) Pub. Date: Oct. 9, 2008

(54) Remote Access to Home Communication Services

(75) Inventors: Sanjay Arunkumar Bhal, Boyds, MD (US); William Paul Simmelink, Gaithersburg, MD (US); Manoj Sindhwani, Oak Hill, VA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/697,600

(22) Filed: Apr. 6, 2007

(51) Int. Cl. H04L 12/28

(52) U.S. Cl. 370/401

(57) ABSTRACT

A home-link gateway system for providing remote access to contracted telephone services at a home or other physical location is disclosed. The home-link gateway manages communications at the home location, for example between a PSTN or VoIP telephone network and local telephone handsets. A remote client agent requests access to telephone services, via the Internet. Following authorization and registration, the home-link gateway couples the remote client agent to the telephone network, or to local handsets, as though the remote client agent were deployed at the home location.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention is in the field of telecommunications, and is more specifically directed to Internet Protocol-based remote access of communications services at an installed location.

As is evident in the marketplace, consumers of modern telecommunications services now have access to a wide range of services. These various services include conventional telephone service over the Public Switched Telephone Network (PSTN), data services over PSTN such as by way of digital subscriber line (DSL) broadband access, cable television service, satellite communications including the receipt of television and radio programming, and of course wireless (i.e., “cellular”) telephone and data services. And each of these services are typically offered under a wide range of pricing plans, depending on the quantity of service used and also on which of a bevy of premium services are desired. With the exception of wireless telephony, these services tend to be offered with connection to a particular physical location, such as a home or office. Many consumers have more than one of these services, each used for a particular application.

Of course, not all consumers are at home every day, but may travel for business or pleasure. When away from home, the traveling consumer often contracts with other telecommunications services to obtain similar functionality as that provided at home. However, the cost of such services when traveling may not be insignificant. For example, telephone service at hotels often entails a substantial per-call fee. Entertainment services are also relatively expensive at hotels. And many cellular telephone plans are geographically limited, at least to within the bounds of a particular country. It is therefore somewhat frustrating for travelers, who pay substantial monthly access fees for services at home, to pay a second fee to use similar services when not at home. In addition, the traveling consumer cannot directly receive telephone calls that are dialed to the home phone number.

In addition, family members may also be living in different places from one another around the country. For example, a college student will often be living away from his or her permanent residence, and from the rest of the family, while away at school. It is of course costly to pay for an additional contract for communications services for such temporarily absent family members, especially on a tight student budget, and also especially considering that college students tend to heavily use such services.

By way of further background, Internet access is now offered at inexpensive rates, if not free-of-charge, at many hotels, airports, coffee shops, travel information centers, and the like.

In addition, given the complexity with which many telephone services and access protocols now operate, most telephone users are comfortable and familiar with the manner in which telephone services are accessed from home, under existing contracts. On the other hand, remote telephone services offered from hotels, or by way of separate contracts such as prepaid telephone cards or credit card payments, are unfamiliar to the traveler. This unfamiliarity is not only functionally frustrating, but can lead to excess charges that the traveler unwittingly incurs because of a mistake.

By way of further background, SLINGBOX remote streaming devices are known in the art. A typical SLINGBOX remote streaming device is installed at a home location, for example between the cable or satellite communications facility and a set top box or television receiver. The device can be remotely controlled to direct live television streams from the communications facility to an Internet connection (e.g., a network router, or a personal computer connected within a local area network). The user of the SLINGBOX remote streaming device can remotely control the device via the Internet, to view the redirected transmissions, or to control the recording of those transmissions in a digital video recorder or in the personal computer hard drive.

### BRIEF SUMMARY OF THE INVENTION

It is an object of this invention to provide a gateway deployed at one physical location that can be accessed from a remote physical location over a wide area network, such as the Internet, to provide remote access to services managed by the gateway.

It is a further object of this invention to provide such a gateway and a method of operating that gateway to provide remote access to telephone services under existing contract terms.

It is a further object of this invention to provide such a gateway and method that allows a remote user to access telephone services using services and features with which the user is already familiar.

It is a further object of this invention to provide such a gateway and method that provides call forwarding of telephone services from the gateway to a remote agent location over the wide area network.

It is a further object of this invention to provide such a gateway and method that provides secure remote access to the telephone services.

Other objects and advantages of this invention will be apparent to those of ordinary skill in the art having reference to the following specification together with its drawings.

This invention may be implemented into a home network system and method of operating the same. A gateway is deployed at one physical location, for example a home. The gateway receives communications facilities and services, such as Public Switched Telephone Network (PSTN) telephony and broadband Internet access supporting voice over Internet Protocol (VoIP) telephony, and is also connected to the Internet, for example over a broadband connection. Other client equipment, such as telephone handsets and the like, are also connected to the gateway at the home location. The gateway is remotely accessible, over the Internet or another wide area network connection, from an Internet-capable device such as a personal computer, personal digital assistant, or wireless telephone handset. Once the gateway is remotely accessed, the user of the remote device can access the services that the gateway manages at the home location, as though the remote device were located at the home location.

### BRIEF DESCRIPTION OF THE SEVERAL VIEWS OF THE DRAWING

FIG. 1 is an electrical diagram, in block form, illustrating a home network configuration according to the preferred embodiment of the invention.

FIG. 2 is an electrical diagram, in block form, of a gateway in the network of FIG. 1, constructed according to the preferred embodiment of the invention.

FIG. 3 is a flow diagram illustrating the establishing of remote telephone services via the gateway of FIG. 2, according to the preferred embodiment of the invention.

FIG. 4 is an electrical diagram, in block form, illustrating the use of the network of FIG. 1 for remote PSTN telephony.

FIG. 5 is an electrical diagram, in block form, illustrating the use of the network of FIG. 1 for remote VoIP telephony.

FIG. 6 is an electrical diagram, in block form, illustrating the use of the network of FIG. 1 for remote intercom communications to a home telephone handset.

FIGS. 7a through 7c illustrate various examples of the operation of the network constructed and operating according to the preferred embodiments of the invention.

### DETAILED DESCRIPTION OF THE INVENTION

This invention will be described in connection with its preferred embodiment, namely as implemented into a home network implementation, because it is contemplated that the invention is especially beneficial when realized in such an implementation. However, it is also contemplated that this invention will be beneficial when used in other applications, such as an office or larger network arrangement, including such a larger-scale network including a private branch exchange (PBX) or other larger-scale telephone network. Accordingly, it is to be understood that the following description is provided by way of example only, and is not intended to limit the true scope of this invention as claimed.

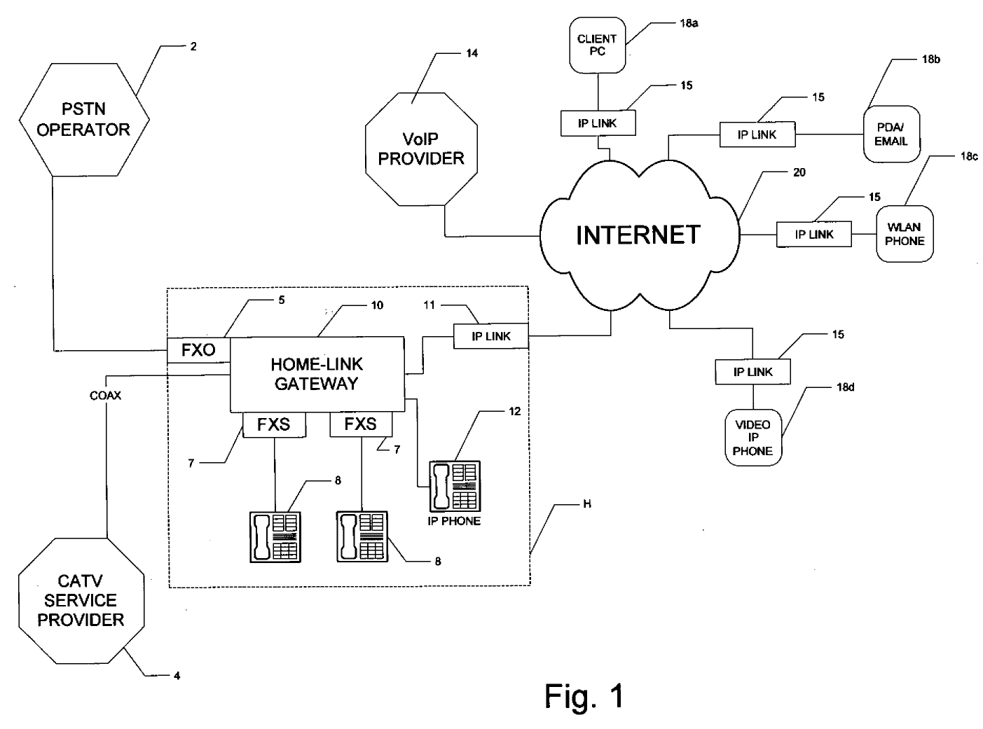

Referring first to FIG. 1, a network installation according to the preferred embodiment of this invention will be described. FIG. 1 illustrates a home network logical topology, in which residents of home H subscribe to multiple telecommunications services. Home H is illustrated by way of a boundary, to denote those network elements and functions that are deployed at the home premises, as distinguished from those network elements deployed elsewhere. In this example, home H includes several connections to various communications facilities. Foreign Exchange Office (FXO) interface 5 in home H is the interface to Public Switched Telephone Network (PSTN) operator 2, and appears as a telephone handset to the PSTN. As conventional in the art, FXO 5 is physically linked to PSTN operator 2 by one or more of twisted-pair wire, fiber optic, satellite link, and other conventional telephone media. On the other side, FXO 5 is linked to or part of home-link gateway 10, which serves as a router and switching function, and a manager of the various services, within home H, as will be described in further detail below. To telephone handsets 8, FXS interface 7 appears as the PSTN. Home-link gateway 10 also includes or links to Foreign Exchange Station (FXS) interfaces 7, each of which connect to a telephone handset 8 within home H. Telephone handsets other than those connected to FXS interfaces 7 may also be supported by home-link gateway 10. For example, home-link gateway 10 may support a directly-connected telephone handset, without requiring an intermediate network functionality (e.g., Ethernet or other LAN), in which case home-link gateway 10 can itself process the input and output signals according to VoIP or other protocol. In the example shown in FIG. 1, home-link gateway 10 also connects directly, in this example, to IP phone 12, with the physical connection being provided by a conventional local area network (LAN) facility within home H.

The LAN facility within home H may be realized as a LAN using conventional technologies, such as Ethernet, power line network (e.g., HOMEPLUG network technology), coaxial LAN (e.g., according to the Multimedia over Coax Alliance, or MoCA, technology), wireless LAN technology, and the like, as well as other LAN technologies that may be developed in the future. In this regard, it is contemplated either that home-link gateway 10 will include support for communications over a LAN facility according to one or more of these technologies, or alternatively that routers and bridges external to home-link gateway 10 will be implemented as necessary. Other devices, such as personal computers and the like, may of course also be included in such a LAN within home H.

Internet Protocol (IP) link 11 in home H serves as an IP link to a wide-area network such as the Internet 20, in the conventional manner. IP communications via IP link 11 are managed and served by home-link gateway 10, as shown in the topology of FIG. 1. For the example of DSL broadband Internet access, IP link 11 may physically correspond to the FXO interface to PSTN operator 2, over which IP communications are carried out. Alternatively, IP link 11 may physically correspond to a cable modem, where the IP communications from home H are provided by CATV service provider 4. As known in the art, other communications media (wireless Internet access, satellite link, etc.) may alternatively physically realize IP link 11. In any case, the IP communications served by IP link 11 are provided to home H under the terms of a service contract with the service provider (e.g., PSTN operator 2, CATV service provider 4). Furthermore, according to this topology, IP link 11 provides access to Voice over IP (VoIP) services provided by VoIP provider 14; for example, IP phone 12 within home H can carry out VoIP communications via home-link gateway 10, IP link 11 (wired or wireless), and the Internet 20, under a contract with VoIP provider 14.

In the network topology shown in FIG. 1 and according to the preferred embodiment of the invention, various remote client devices can access home-link gateway 10 and services supported by it. In this example, remotely located client personal computer 18a, personal digital assistant (PDA) or other email device 18b, wireless LAN telephone handset 18c, and video-enabled IP phone 18d, each of which are connected to the Internet 20 via IP link 15, are capable of accessing home-link gateway 10 via the Internet 20 and IP link 11. For example, the resident of home H can use one of clients 18 to access home-link gateway 10, via an IP link 15 at a hotel, airport, coffee shop, travel information center, or the like. It is contemplated that any device capable of obtaining Internet access, at a location at which such Internet access is provided, can access the services and functions at home H described in this specification. As will be described in detail below, home-link gateway 10 provides the functionality and support by way of which each of these devices, namely client PC 18a, PDA 18b, WLAN phone 18c, or video-enabled IP phone 18d in FIG. 1, can utilize the PSTN or VoIP services provided to home H, operating as a remote “home-link agent” in the access of services managed and supported by home-link gateway 10 under the existing service contracts.

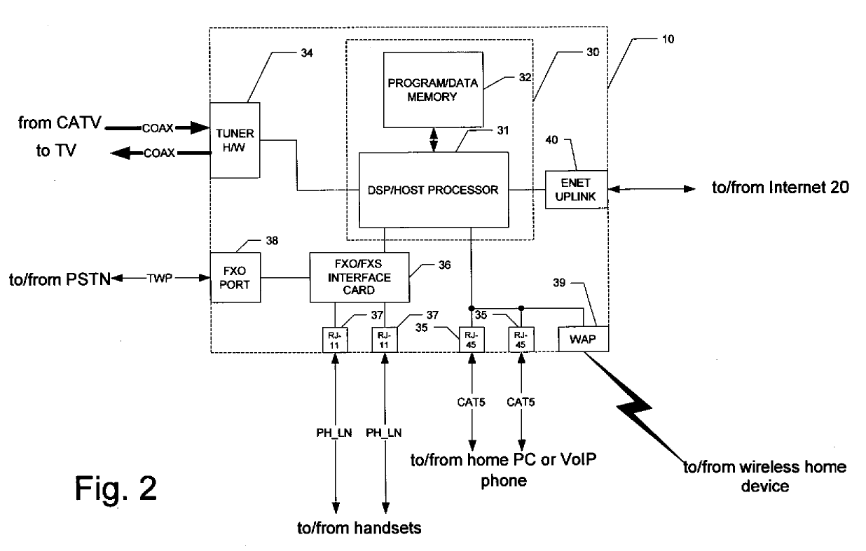

FIG. 2 illustrates an example of the construction of home-link gateway 10, according to the preferred embodiment of the invention. The architecture illustrated in FIG. 2 is presented by way of example only, and is not intended to be exhaustive of the manner in which home-link gateway 10 may be realized. It is contemplated that those skilled in the art having reference to this specification will be readily able to realize the functions of home-link gateway 10 according to variations on this architecture, or indeed by way of alternative architectures.

As shown in FIG. 2, home-link gateway 10 is controlled by “System on a Chip” (SoC) 30, which includes an embedded processor for control of the signaling among the various physical media to which home-link gateway 10 interfaces. As known in the art, a “System on a Chip” (SoC) architectures realize a relatively full digital processing system on a single integrated circuit, and as such typically include a microprocessor or programmable processor core 31, as well as memory 32 and input/output resources (not shown). For example, core 31 of SoC 30 may be realized by integrating a modern digital signal processor (DSP) device, with a general purpose Reduced Instruction Set Computer (RISC) machine such as those of the ARM and MIPS architectures. Examples of SoC devices suitable for use as SoC 30 in this embodiment of the invention include those SoC devices in the OMAP and PETRA families of SoCs available from Texas Instruments Incorporated. Core 31 is connected to program and data memory 32; the program portion of memory 32 may be realized at least in part by hard disk storage or other non-volatile memory resources, for storing the executable instructions according to which home-link gateway 10 carries out the control functions described in this specification; the data portion of memory 32 may, of course, include both non-volatile and volatile memory for storing the data required and useful in carrying out these functions. Of course, the functions of SoC 30 in this embodiment of the invention may be alternatively realized by multiple integrated circuit devices or a Multi-Chip Module (MCM), if desired.

For the services supported in the topology example of FIG. 1, home-link gateway 10 includes ports and interface functions as shown in FIG. 2. FXO/FXS interface 36 in home-link gateway 10 provides support and functionality to carry out conventional telephony, and as such is coupled to SoC 30. FXO port 38 is connected to FXO/FXS interface card 36, through which connection is made between home-link gateway 10 and the PSTN, typically by way of RJ-11 hardware and twisted-pair wire media. FXO port 38 is, of course, the interface to the PSTN, and as such FXO port 38 appears, to the PSTN, as a conventional telephone device. On the FXS side, FXO/FXS interface card 36 also connects, via RJ-11 jacks 37 and conventional phone lines PH_LN, to conventional telephone handsets (e.g., handsets 8 in FIG. 1). The FXS ports of FXO/FXS interface card 36 appear, to telephone handsets 8, as the PSTN itself, as known in the art for FXS interface devices and functions. It is contemplated that those skilled in the art can realize FXO/FXS interface card 36 in home-link gateway 10, according to conventional construction for such functionality, without undue experimentation.

Home-link gateway 10 also includes functionality for local area network (LAN) access within home H. As shown in FIG. 2, SoC 30 is bidirectionally coupled to multiple LAN connections, including RJ-45 jacks 35 to which client devices such as the network adapter in a client PC or a VoIP telephone handset (e.g., phone 13 in FIG. 1) can be connected via conventional network cable CAT5. In addition, wireless access point (WAP) functionality 39 is also provided within home-link gateway 10 according to this embodiment of the invention, for wireless LAN communication with client devices within home H.

Other types of local area network arrangements may alternatively or additionally be supported by home-link gateway 10. For example, home-link gateway 10 may support coaxial cable in-home LAN communications, as described in U.S. Pat. No. 6,941,576 B2 and in copending U.S. patent application Ser. No. 09/636,019, filed Aug. 10, 2000, both assigned to Texas Instruments Incorporated and incorporated herein by this reference.

It is contemplated that some or all of the functionality of home-link gateway 10 may be integrated into one or more than one integrated circuits. For example, the communications functions of FXO/FXS interface card 36, and those functions involved in LAN communications via RJ-45 jacks 35 and WAP functionality 39, may be realized by portions of conventional systems such as the TNETV1061 residential gateway from Texas Instruments Incorporated.

According to the preferred embodiment of the invention, home-link gateway 10 may include Ethernet uplink function 40, which serves as a high-speed Ethernet port by way of which home-link gateway 10 communicates with the Internet 20. Home-link gateway 10 may include its own modulator/demodulator (“modem”) functionality for formatting communications transmitted to and received from the Internet 20, for example according to broadband techniques known in the art for DSL and cable modem data communications, or alternatively a separate modem (not shown) may be provided externally from home-link gateway 10, and connected between Ethernet uplink 40 and the corresponding physical communications facility (e.g., twisted-pair wire for DSL, coaxial cable for cable modem communications, wireless signals for wireless or satellite communications, etc.).

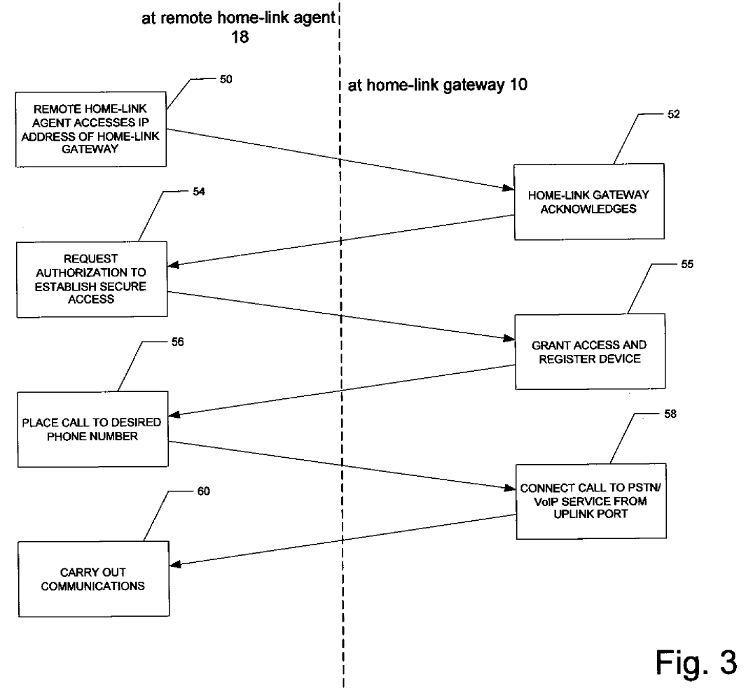

According to the preferred embodiment of the invention, as will now be described, home-link gateway 10 provides remote access, via the Internet 20 and uplink function 40, to the telephony services that it supports and manages within home H. It is contemplated that this access and management of this access will be carried out by core 31 in SoC 30, through the execution of program instructions stored in memory 32; of course, this functionality may also be realized by custom hardware, as determined by the skilled artisan having reference to this specification. FIG. 3 illustrates, by way of a flow diagram, the carrying out of such access and management.

Remote telephone access begins in process 50, by way of which a remote home-link agent 18 (e.g., one of client PC 18a, PDA 18b, WLAN phone 18c, and video-enabled IP phone 18d of FIG. 1, via a corresponding IP link 15) accesses home-link gateway 10 via the Internet 20. Preferably, an application program is previously uploaded to or otherwise resident on remote home-link agent 18, with a menu driven or automatic IP address for home-link gateway 10 stored at the home-link agent, to facilitate access process 50. In any event, process 50 includes the access by remote home-link agent 18 to the IP address of the specific home-link gateway 10 located at the home or other location with which the user is associated. This access preferably includes some identifier of remote home-link agent 18 itself, especially if the telephone service provider for home H requires such identification for purposes of compliance with the service contract. In process 52, the addressed home-link gateway 10 acknowledges remote home-link agent 18 that executed process 50, causing remote home-link agent 18 to initiate authorization process 54.

Authorization process 54 is preferred, according to this embodiment of the invention, to ensure secure access by a remote device to the services supported by home-link gateway 10, as well as to ensure that call forwarding and other services described below are not accessible to unauthorized users. It is contemplated that some sort of conventional authentication and authorization routine may be performed in connection with process 54, such conventional routines including password communication, or the use of public/private key pair authentication, and the like. If the authorization request of process 54 is valid for this session, home-link gateway 10 grants remote home-link agent 18 access to its services.

In addition, in process 55, home-link gateway 10 preferably “registers” remote home-link agent 18 in its supported network; this “registering” of home-link agent 18 enables home-link gateway 10, and other resident network elements in home H (handset 8) to be aware that remote home-link agent 18 has accessed home-link gateway 10, and is available not only to initiate communications but also to receive communications. For example, it is contemplated that handsets 8 or IP phone 12 may be able to call a registered remote home-link agent 18, via home-link gateway 10, by way of an “intercom” or other local function, as though home-link agent 18 were another telephone handset within home H. In addition, it is contemplated that calls to one or more of the telephone numbers associated with home H may be forwarded to remote home-link agent 18, once it is registered in process 55 and a forwarding function within home-link gateway 10 executed and enabled, so that a traveler may appear, to telephone callers, as though he or she is “at home”, despite being away.

In addition, it is contemplated that this forwarding may be done intelligently, in that a set of rules may be configured within SoC 30 by a configuration interface or alternatively by one of remote home-link agents 18, according to which the calls may be forwarded to the registered remote home-link agent 18. For example, call forwarding may be enabled for certain times of the day, or for incoming calls from a list of telephone numbers, or calls that are directed to a particular “extension” within home H; of course, conventional call forwarding on no answer, or for all calls unconditionally, is also contemplated. It is also contemplated that more than one remote home-link agent 18 may be registered with the home-link gateway 10, and that a different set of rules may apply to different ones of the registered remote home-link agents 18. Further in the alternative, it is contemplated that home-link gateway 10 may include some sort of voice mail or other message storing capability, such that a forwarded call may be locally stored at home-link gateway 10 if an incoming call is directed to one of the registered home-link agents 18, but is not answered for some reason.

Referring back to FIG. 3, upon its authorization and registration, remote home-link agent 18 can now place a call, in process 56, to a desired telephone that is accessible via one of the telephony services supported by home-link gateway 10, according to and under the terms of an active telephone service contract provider. In process 58, home-link gateway 10 functionally connects uplink port 40 (through which remote home-link agent 18 is accessible) to the corresponding PSTN or VoIP port, in similar manner as a telephone call initiated by one of local handsets 8 or IP phone 12. Typically, the placing of this call will involve the transmission of a destination identifier for the call; conventionally, this destination identifier is a telephone number (i.e., similarly as placing a call over the PSTN), but alternatively the destination identifier may be some in some other format, such as a link to an entry in a telephone directory stored within home-link gateway 10 (in which case the user of remote home-link agent 18 would not know the telephone number), or an IP address or URL. In this regard, home-link gateway 10 processes and formats the IP communications from remote home-link agent 18 into signals suitable for communication over the PSTN, or as IP packets suitable for communication over the VoIP network. In any case, the call placed remotely by home-link agent 18 is serviced, by the appropriate service provider, under the terms of the service contract applicable to home H, regardless of the physical location of remote home-link agent 18. In process 60, remote home-link agent 18 carries out the communications over that call, via Internet 20 and home-link gateway 10.

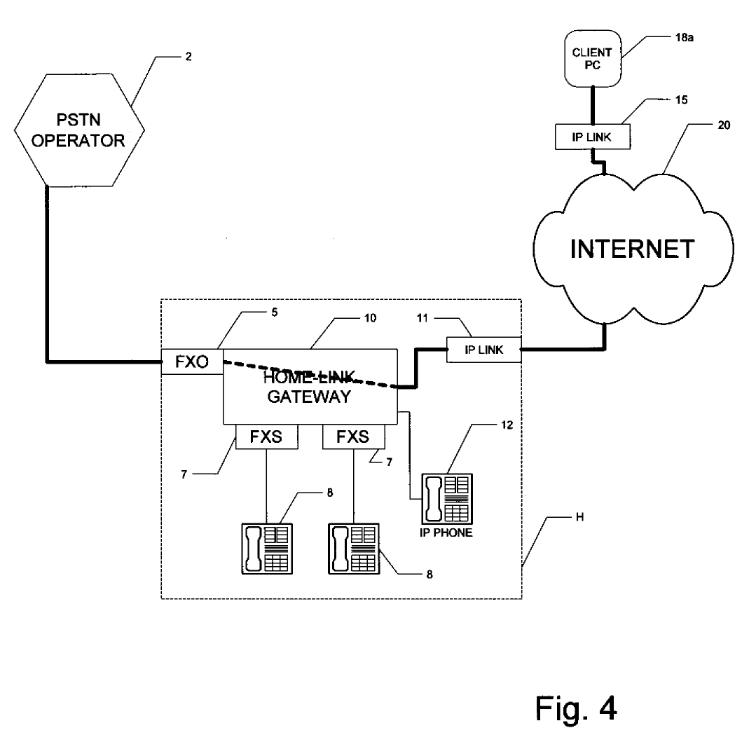

FIG. 4 illustrates the logical arrangement of a telephone call from client PC 18a, serving as a remote home-link agent 18, to a telephone number on the PSTN, under the terms of a contract between home H and PSTN operator 2. As shown in FIG. 4, client PC 18a is connected, via IP link 15 at its remote location, to the Internet 20, and through the Internet 20 to the IP address of home-link gateway 10. Upon authorization, authentication, and registration, a telephone call placed from client PC 18a is then routed by home-link gateway 10 to FXO port 8, and to the PSTN. From the viewpoint of the PSTN (and thus PSTN operator 2), the call placed from remotely-located client PC 18a, as remote home-link agent 18, appears as any other telephone call from home H. Accordingly, PSTN operator 2 carries this call in the same manner, and under the same contract terms, as any other call from home H. Similarly, following the logical diagram of FIG. 4, if client PC 18a has enabled call forwarding via home-link gateway 10, an incoming call from the PSTN to a number associated with home H may be routed by home-link gateway 10, via IP link 11 and the Internet 20, to client PC 18a, despite its remote location.

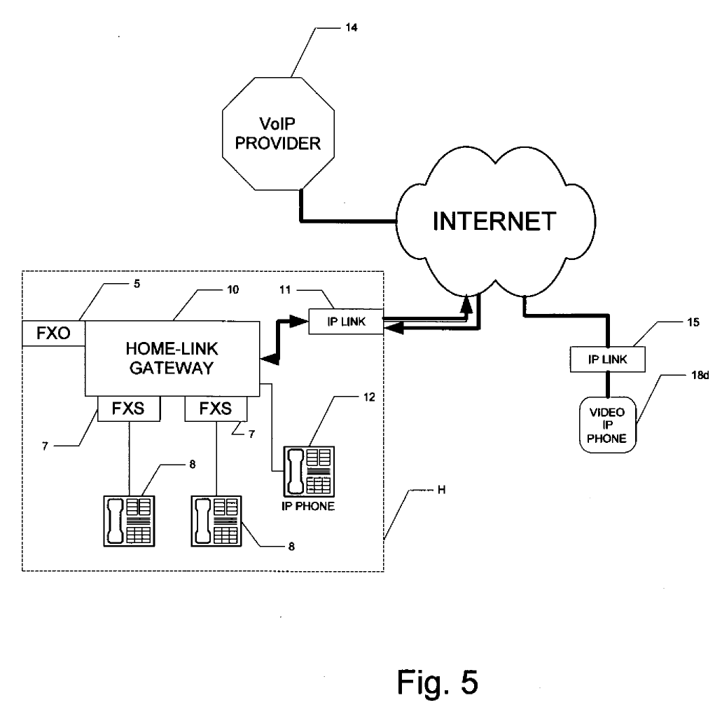

FIG. 5 illustrates an alternative arrangement, in which remote video-enabled IP phone 18d serves as remote home-link agent 18, and uses home-link gateway 10 to manage a VoIP telephone call. Video-enabled IP phone 18d in this example is remotely located, away from home H, and via IP link 15, communicates with home-link gateway 10 as described above to obtain access to telephony services at home H. In this example, video-enabled IP phone 18d wishes to access the VoIP services supported by VoIP provider 14, under a contract with the resident of home H. As such, incoming IP communications from video-enabled IP phone 18d over the Internet 20 are routed by home-link gateway 10 back out via IP link 11 to the Internet 20, but addressed to the IP address of VoIP provider 14, in the conventional manner for VoIP communications; of course, communications from the called number are forwarded from VoIP provider 14, over the Internet 20, and routed by home-link gateway 10 back out to the Internet to video-enabled IP phone 18d. In this manner, remotely-located video-enabled IP phone 18d, as a remote home-link agent 18, is able to place, receive, and conduct VoIP telephone communications as though such communications were being carried out at home H. No additional contract need be obtained, and the interface and procedures for making such a call, once video-enabled IP phone 18d is authorized and registered, can be the same as if done at home H (e.g., by IP phone 12).

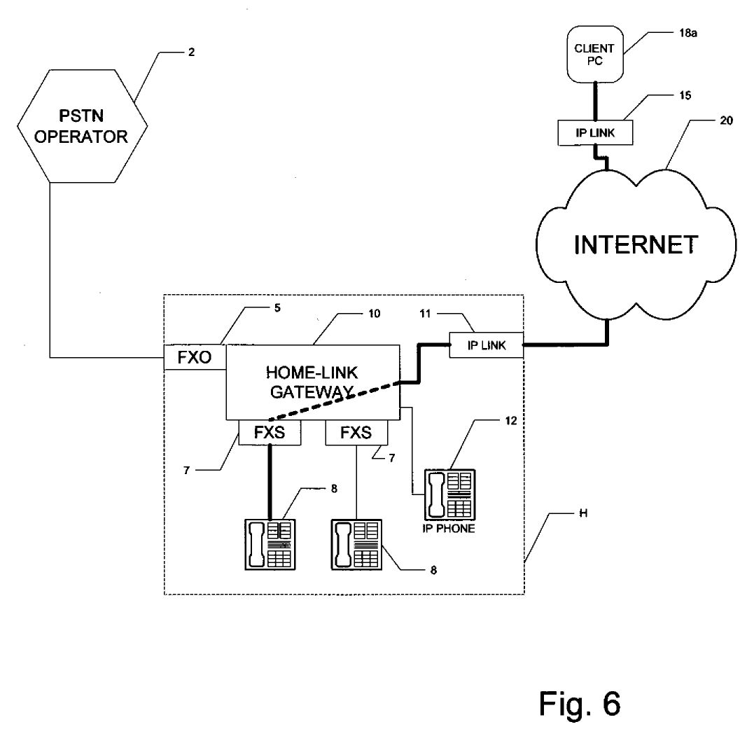

FIG. 6 illustrates another situation, similar to that described above relative to FIG. 4, in which client PC 18a serves as a remote home-link agent 18. In this example, however, the access provided by home-link gateway 10 is an intercom function to handset 8 within home H, and does not involve PSTN operator 2. As shown in FIG. 6, client PC 18a is again connected, via IP link 15 and the Internet 20, to the IP address of home-link gateway 10. In this example, however, the call placed by client PC 18a (in process 56 of FIG. 3) is to another “extension” within home H, specifically one of handsets 8. Home-link gateway 10 thus routes intercom communications between remote client PC 18a and handset 8, at no contract charge. As such, there are no long distance or other telephone charges required for carrying out this intercom call (i.e., other than any fee required by remote client PC 18a to access the Internet 20).

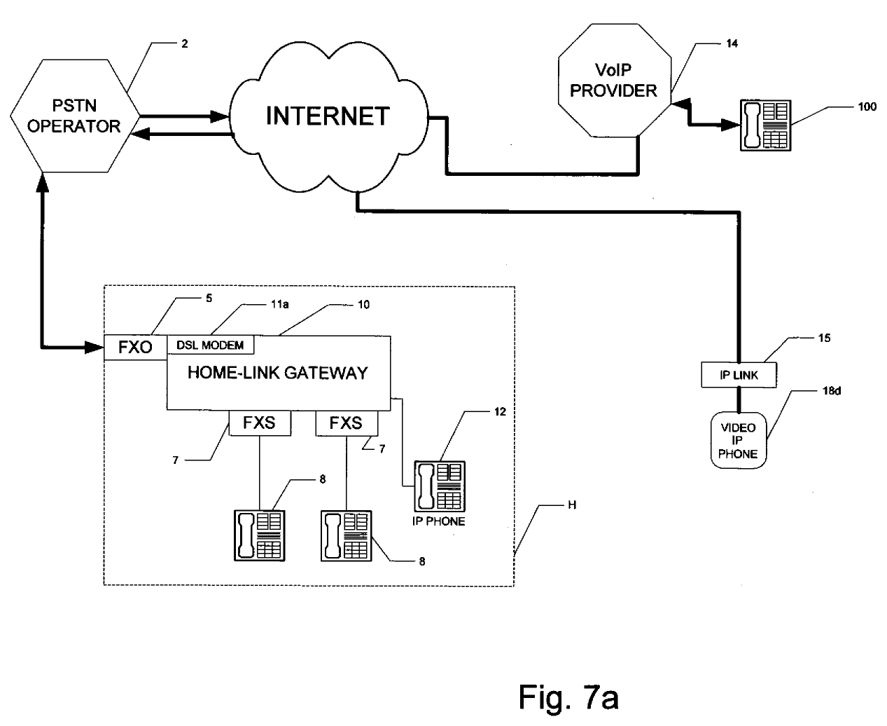

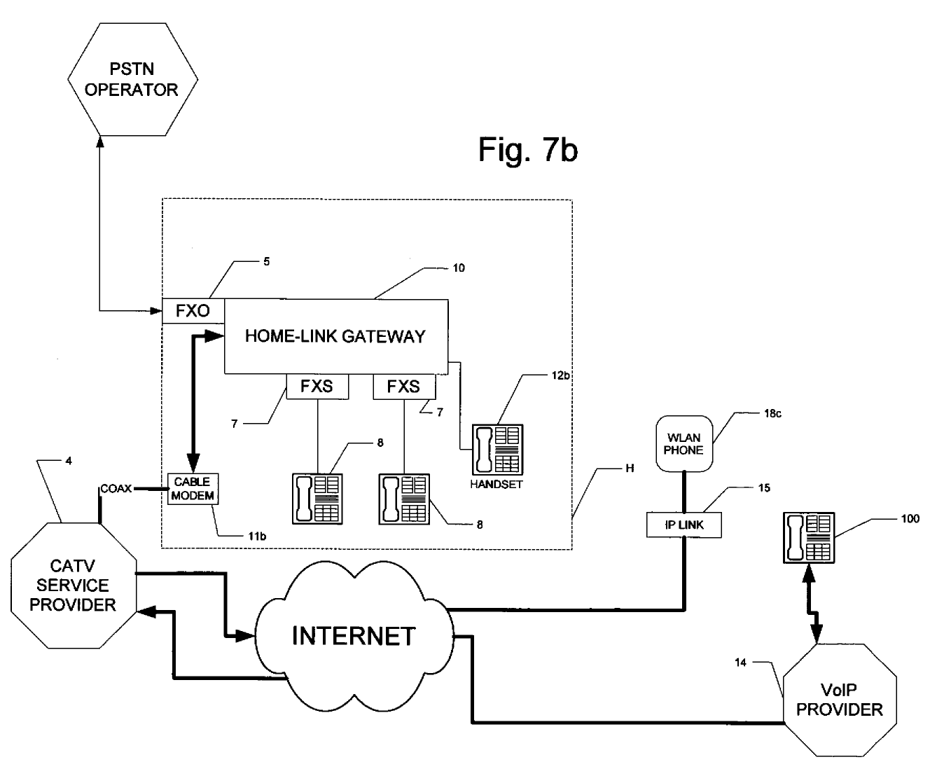

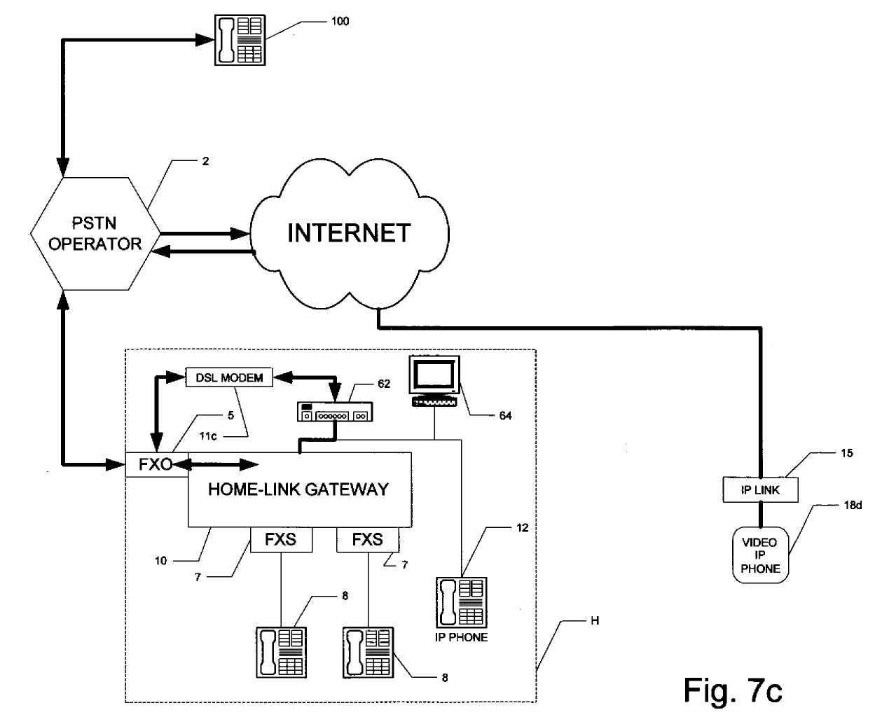

FIGS. 7a through 7c illustrate, in further detail, other examples of the manner in which communications may be carried out in connection with the preferred embodiments of this invention. In the example of FIG. 7a, telephone communications are to be carried out between video IP phone 18d, as the remote home-link agent, and VoIP telephone 100. As discussed above, either video IP phone 18d places the call to the phone number associated with VoIP telephone 100, or the call is placed by VoIP telephone 100 to a phone number associated with home H and forwarded or otherwise directed to the registered home-link agent of video IP phone 18d. In either case, video IP phone 18d is in communication, over the Internet by way of Internet Protocol communications, to home-link gateway 10. In this situation, PSTN operator 2 is also the Internet service provider (ISP) to home H, by way of DSL communications communicated over the PSTN twisted-pair facility received by home-link gateway 10 via FXO 5. In this example, IP link 11 at home H is realized by way of DSL modem function 11a that is built into home-link gateway 10.

In operation, communications from IP phone 18d are forwarded over the Internet, through the ISP of PSTN operator 2, into home-link gateway 10 via FXO 5 and DSL modem function 11a. These telephone communications are then sent back out to PSTN operator 2 via DSL modem 11a and FXO 5, but under the VoIP or ISP contract terms established by the resident of home H and PSTN operator 2. PSTN operator 2 then directs these communications to the phone number associated with telephone 100, which in this case is a VoIP telephone served by VoIP provider 14 (under contract with the owner of telephone 100). Communications in the opposite direction, of course, follow substantially the same path in the reverse direction, into and out of home-link gateway 10.

FIG. 7b illustrates another communications session supported by another configuration of home-link gateway 10 according to the preferred embodiments of this invention. In this example, the remote home-link agent is wireless LAN phone 18c, which connects to the Internet by way of its IP link 15, however configured. As shown in FIG. 7b, the ISP for home H is CATV service provider 4, and as such IP link 11 within home H is realized by cable modem 11b. Cable modem 11b may be an external device connected or coupled to home-link gateway 10, as shown in FIG. 7b; alternatively, of course, cable modem functionality may be built into home-link gateway 10. In this situation of FIG. 7b, similarly as in FIG. 7a described above, the telephone communications are to be carried out between WLAN phone 18c, as the remote home-link agent, and VoIP telephone 100, with either device being capable of placing the call, as described above.

In operation, communications from WLAN phone 18c are forwarded over the Internet, and via CATV service provider 4 as the ISP for home H, into home-link gateway 10 via cable modem function 11b. Home-link gateway 10 processes these signals as necessary or desired, and forwards the telephone communications over the coaxial facility to CATV service provider 4, via cable mode 11b, under the terms of the VoIP and ISP contracts between the resident of home H and CATV service provider 4. CATV service provider 4 then directs these communications to the phone number associated with telephone 100, which in this case is again a VoIP telephone served by VoIP provider 14 (under contract with the owner of telephone 100). VoIP provider 14 may, of course, be the same party or entity as CATV service provider 4 offering VoIP services. Communications in the opposite direction are handled by these same parties and functions, of course in the reverse direction into and out of home-link gateway 10.

FIG. 7c illustrates an arrangement in which telephone communications are being carried out between the remote home-link agent of video IP phone 18d, and PSTN telephone 100. Also, in this example, IP link 11 at home H is realized by an external DSL modem 11c, which is connected to FXO interface 5 on one side, and to home-link gateway 10 via router 62 on the other side. Router 62 supports a LAN upon which home-link gateway 10, personal computer 64, and IP phone 12 reside; of course, other network elements may also reside on this LAN.

In operation, communications from video IP phone 18d are forwarded over the Internet, and via PSTN operator 2 as the ISP for home H, into home-link gateway 10 via FXO interface 5, DSL modem 11a, and router 62. Home-link gateway 10 processes and forwards these signals back to PSTN operator 2. However, because this call is to be transmitted from home-link gateway 10 as a PSTN telephone call, under the terms of the PSTN local or long-distance telephone service contract between the resident of home H and PSTN operator 2, home-link gateway 10 formats the IP signals received from video IP phone 18d into signals for PSTN telephone communications, and forwards these signals out via FXO interface 5 to PSTN operator 2, which in turn communicates these signals to telephone 100 over the PSTN. Communications in the opposite direction are handled by these same parties and functions, of course in the reverse direction into and out of home-link gateway 10. Specifically, communications from telephone 100 are transmitted over the PSTN and FXO interface 5 to home-link gateway 10, which formats the communications signals into IP packets or the like, and communicates those packets to video IP phone 18d via the LAN supported by router 62, DSL modem 11c, FXO interface 5, and PSTN operator 2 under the ISP contract terms between the resident of home H and PSTN operator 2. These signals then reach the Internet and are communicated via IP link 15 to video IP phone 18d.

It is contemplated that arrangements and situations other than those illustrated in FIGS. 4 through 6 and in FIGS. 7a through 7c will be apparent to those skilled in the art having reference to this specification. As evident from these few examples, the variations on the use of a home-based telephone contract (whether PSTN or VoIP) from a remote location can vary in many different ways, as can the particular hardware and functions involved within home H and at the remote location. Accordingly, these examples are provided merely to illustrate a wide range of services and access situations that are enabled by this invention, and as such are not intended to limit the true scope of this invention.

As a result of this invention, a remote user can use an existing telephone service contract and arrangement, based on telephone service to a home location, to place and receive telephone calls. For example, a telephone call that is placed from home H to a number in its “local” telephone service area involves no “long-distance” charges; this invention enables a traveler to place such a “local” call (for billing purposes) from a remote location, indeed from overseas. The call forwarding functionality provided by this invention to a remote home-link agent, once registered with the home-link gateway, also permits receipt of a “local” phone call, as though the user were physically present in the local home. The contract price for long-distance telephone services, whether PSTN or VoIP, may also be sufficiently low that it is economically beneficial for the remote user to place those calls through his home location, via the home-link gateway of this invention, rather than as a long distance or other call from his remote location; this invention provides this ability. And the remotely-located user is able to access these telephone services in a familiar manner, without frustration from unfamiliar calling protocols, and avoiding high extra charges that can result from mistakes made in selecting and following unfamiliar procedures.

While this invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A home-link gateway for controlling communications within a home, comprising:
a telephone network interface, for coupling to a telephone communications facility for receiving and transmitting telephone communications to a telephone network;
at least one local telephone interface, for coupling to a telephone handset at a location of the home-link gateway;
a wide-area network link, for coupling to a wide area network; and
circuitry for managing telephone communications between a remote client communicating via the wide-area network link and the telephone network, by authenticating the remote client and forwarding communications between the wide-area network link and the telephone network interface.

2. The gateway of claim 1, wherein the telephone network is the Public Switched Telephone Network;
and wherein the telephone network interface comprises a Foreign Exchange Office interface.

3. The gateway of claim 2, wherein the at least one local telephone interface comprises a Foreign Exchange Station interface.

4. The gateway of claim 2, wherein the wide-area network link comprises an Internet Protocol link.

5. The gateway of claim 2, wherein the wide-area network link comprises a broadband modem function.

6. The gateway of claim 1, wherein the telephone network is a Voice over Internet Protocol service;
wherein the wide-area network interface comprises an Internet Protocol link;
and wherein the managing circuitry is also for receiving Internet Protocol communications from the remote client over the Internet Protocol link, and for transmitting corresponding Voice over Internet Protocol communications to the Voice over Internet Protocol service over the Internet Protocol link.

7. The gateway of claim 6, wherein the at least one local telephone interface comprises a local area network interface.

8. The gateway of claim 1, wherein the managing circuitry is also for managing telephone communications between the remote client communicating via the wide-area network link and a telephone handset coupled to one of the at least one local telephone interface.

9. The gateway of claim 1, wherein the managing circuitry comprises:
a programmable processor system, coupled to the wide-area network link;
an FXO/FXS interface function, coupled to the at least one local telephone interface and to the programmable processor system; and
memory for storing program instructions executable by the programmable processor to perform the authenticating and forwarding functions.

10. The gateway of claim 9, further comprising:
at least one local area network interface, coupled to the programmable processor system.

11. A method of providing telephone communication services at a first physical location for a client device at a second physical location remote from the first physical location, comprising the steps of:
receiving a remote access request from the client device over a wide-area network interface;
authorizing the client device for telephone communications;
then receiving a communication from the remote client comprising a destination identifier for a desired telephone call;
forwarding signals to a telephone network requesting placement of a call corresponding to the destination identifier; and
forwarding communications signals between the telephone network and the remote client, over the wide-area network interface, to carry out the telephone communications.

12. The method of claim 11, wherein the telephone network is the Public Switched Telephone Network.

13. The method of claim 12, wherein the wide-area network link comprises an Internet Protocol link;
and wherein the step of forwarding communications signals comprises formatting Voice over Internet Protocol signals into signals suitable for communications over the Public Switched Telephone Network, and vice versa.

14. The method of claim 11, wherein the telephone network is a Voice over Internet Protocol service;
wherein the wide-area network interface comprises an Internet Protocol link;
and wherein the step of forwarding communications signals comprises:
receiving Internet Protocol signals from the remote client over the Internet Protocol link; and
formatting signals into a suitable format for Voice over Internet Protocol communications, over the Internet Protocol link.

15. The method of claim 11, further comprising:
after the authorizing step, registering the remote client as a network element at the first physical location; and
formatting signals received from the registered remote client into a form suitable for a local telephone device at the first physical location, and vice versa.

16. The method of claim 15, wherein the local telephone device comprises a telephone handset suitable for communication over the Public Switched Telephone Network;
and wherein the step of formatting signals formats signals received from the registered remote client into an analog form, and vice versa.

17. The method of claim 15, wherein the local telephone device comprises a Voice over Internet Protocol telephone handset.
and wherein the step of formatting signals formats signals received from the registered remote client into a suitable format for Voice over Internet Protocol communications, and vice versa.

18. The method of claim 11, further comprising:
after the authorizing step, registering the remote client as a network element at the first physical location;
receiving an incoming telephone call from the telephone network; and
forwarding signals corresponding to the incoming telephone call to the registered remote client over the wide-area network interface.

19. The method of claim 11, further comprising:
after the authorizing step, registering the remote client as a network element at the first physical location;
responsive to a request from a local telephone handset, initiating a telephone call with the registered remote client; and
then forwarding communications signals between the local telephone handset and the registered remote client.

20. The method of claim 19, wherein the then forwarding step comprises:
formatting signals received from the registered remote client into an analog form, and vice versa.

21. The method of claim 19, wherein the then forwarding step comprises:
formatting signals received from the registered remote client into a suitable format for Voice over Internet Protocol communications, and vice versa.

22. The method of claim 11, further comprising:
after the authorizing step, registering the remote client as a network element at the first physical location;
storing at least one call-forwarding rule;
comparing at least one attribute of an incoming telephone call from the telephone network to the at least one call-forwarding rule; and
responsive to the comparing step determining that the at least one attribute matches the at least one call-forwarding rule, forwarding signals received from the telephone network to the registered remote client.

23. The method of claim 22, wherein the at least one rule corresponds to a set of at least one telephone number associated with the incoming telephone call.

24. The method of claim 22, wherein the at least one rule corresponds to a time of day of the incoming telephone call.

25. The method of claim 22, wherein the registering step is repeated for a second remote client;
and wherein the step of storing at least one call-forwarding rule is repeated for the second remote client, the rules for each of the remote clients differing from one another.
